(19) United States
(12) Patent Application Publication
(10) Pub. No.: US 2007/0112386 A1
(43) Pub. Date: May 17, 2007

(54) Pacifier for infants and toddlers

(76) Inventor: Stephen R. Branam, Sylvania, OH (US)

Correspondence Address: PURDUE LAW OFFICES;2735 N. HOLLAND-SYLVANIA ROAD, SUITE B-2, TOLDEO, OH, 43615, US

(21) Appl. No.: 11/647,853

(22) Filed: Dec. 29, 2006

Related U.S. Application Data
(63) Continuation-in-part of application No. 10/172,602, filed on Jun. 14, 2002.
(60) Provisional application No. 60/318,114, filed on Sep. 7, 2001.

(51) Int. Cl. A61J 17/00

(52) U.S. Cl. 606/234

(57) ABSTRACT

A new and improved pacifier including a novel nipple structure is disclosed. The nipple structure includes a short nipple that allows the tongue, during sucking and swallowing, to be naturally positioned adjacent to the hard palate. The nipple structure includes a thin and pliable web which extends beyond the tip of the nipple and, in use, is received between the tongue and the palate. Preferably, the web terminates near the mid-point, front to back, of the hard palate of a user. The web is so thin and pliable that it will deform to conform to the shape of a hard palate when pressed by a tongue thereagainst. Preferably, the web has a featheredge. The web, when received between the tongue and the hard palate, will facilitate the retention of the pacifier in the mouth.

### REFERENCE TO RELATED APPLICATION

This is a continuation in part of application Ser. No. 10/172,602 filed Jun. 14, 2002, now. The benefit of the filing date of Provisional application No. 60/318,114, Filed Sep. 7, 2001, is claimed for subject matter disclosed therein.

### BACKGROUND OF THE INVENTION

1. Field of the Invention

The present invention relates generally to pacifiers for infants and toddlers. More specifically, the invention is directed to a pacifier wherein the nipple is configured to minimize nipple confusion and the pacifier is designed to promote infant and toddler acceptance of it and includes a web to promote and facilitate the retention of the pacifier in the mouth of an infant or toddler. while reducing unwanted side effects associated with conventional pacifiers.

2. Description of the Prior Art

The art of pacifiers for infants and toddlers is well developed. Tens of millions of pacifiers are sold annually in the United States.

U.S. Pat. No. 4,545,378 discloses a baby pacifier comprising a shield, which, in use, is positioned outside the mouth, and a nipple, or baglet that is connected to the shield and adapted to extend into the mouth. The patent discloses an improved connection between the shield and the baglet. The nipple portion of the pacifier is fairly long and, in use, is believed to contribute to undesirable pressure on the upper palate.

U.S. Pat. No. 5,300,089 discloses a pacifier, which is designed to simulate a human breast. The nipple head is provided with a cavity to contain a fluid or freezable gel which can be cooled or frozen for soothing purposes.

U.S. Pat. No. 5,334,218 discloses a so-called teething pacifier with a semi-circular teething member. The teething member is configured to be positioned between the upper and lower gums of an infant or toddler. The device disclosed, however, is configured so that, in use, it will cause distortion of the upper and lower jaw because, as explained below in more detail, it has parallel upper and lower surfaces, which do not account for proper spacing between the upper and lower gums with or without erupted teeth.

U.S. Design Pat. Nos. 231,033 and 245,335 disclose designs for pacifiers.

U.S. Design Pat. No. 300,059 discloses a design for a mouthpiece for a geriatric pacifier or for the treatment of bruxism.

U.S. Design Pat. No. 273,515 discloses a design for an orthodontic nipple.

Oral screens are known, and are available from Great Lakes Orthodontics. Such screens comprise a curved element, which is received between the gums and the cheeks. They may include a screen, which is positioned to prevent undesirable tongue thrusting which is associated with improper oral development. Pediatric dentists distribute oral screens to young patients for the purpose of weaning them from using conventional pacifiers.

Recently, studies have demonstrated that the use of conventional pacifiers may lead to problems in a significant population of those who use them. For example, it is reported by Maijo Niemela et al that a study of 944 five-year-olds “revealed that children who had used conventional pacifiers had a greater risk of having recurrent attacks of acute otitis media or middle ear infections than those who had not used pacifiers.” Int. J. Ped. Otorhin, volume 29, pages 121-127 (1994). Further, it has been observed that the use of conventional pacifiers promotes constriction of the maxilla due to pressure exerted by the cheeks, which are drawn inwardly when an infant sucks on a conventional pacifier. The maxilla and especially the alveolar ridge tend to distort in response to external forces. This phenomenon is the foundation of modem orthodontia in which the orientation of the maxilla and the teeth is altered in a desirable way. Conventional pacifiers are also believed to promote undesirable tongue thrusting habits, which can contribute to undesirable pressure on the palate, which, in extreme cases, can compromise the function of the Eustachian tubes and is associated with middle ear trouble. This is believed to be due to the fact that the nipple portions of conventional pacifiers extend too far into the mouth.

My prior U.S. Pat. No. 5,814,074, the disclosure of which is incorporated herein by reference, discloses an oral appliance for infants and toddlers, which is constructed so as not to contribute to orthodontic problems or increase the risk of middle ear infections. The appliance comprises an outer shield, an inner shield, a connector element and a nipple element. The outer shield is supported on the connector element and, in use, rests against the outside of the cheeks. The inner shield is also supported on the connector element so that it is spaced from the outer shield a distance such that an infant's cheeks and lips are easily received therebetween. The inner shield is adapted to be positioned between an infant's gums and cheeks and is configured to prevent the cheeks, during sucking, from collapsing and exerting undesirable pressure on the maxilla. The nipple element is shorter than nipple elements in conventional pacifiers and is substantially flattened to provide better tongue positioning and to resist undesirable tongue thrusting. The connector element, which, in use, is received between a child's upper and lower lips, is flattened to allow for a more normal lip closure than do nipple elements in conventional pacifiers. In a toddler embodiment of the appliance of the patented invention, there is provided a tapered bite ridge, which extends inwardly from the inner shield and is thicker adjacent to the nipple than it is at its ends. In use, the bite ridge is positioned between the upper and lower surfaces of erupted teeth and the variation in thickness of the bite ridge promotes the establishment of a level bite plane between the teeth.

I have discovered that the oral appliance disclosed in my prior patent may not always be readily accepted and retained by a young child, especially an infant. In addition, parental acceptance of such an appliance is believed to be hampered by its novelty and because of the vast differences between the appliance and conventional pacifiers with which they are familiar. I have further discovered that the shortened nipple, apart from the other features of the oral appliance, has benefits in terms of reducing the incidence of orthodontic problems and middle ear infections associated with other conventional pacifiers. However, a simple pacifier with a shortened nipple of the type associated with my oral appliance would not be as attractive to some infants as a more conventional pacifier with the traditional longer nipples. Thus, there is a need for a pacifier that is readily accepted and easily retained in the mouth by toddlers and infants, especially one that provides the benefits associated with the shortened nipple in the oral appliance disclosed in my prior patent.

### SUMMARY OF THE INVENTION

The present invention is based upon the discovery of a new and improved nipple structure for a pacifier. The nipple element is short, approximately one half inch, and allows the tongue, during swallowing, to be naturally positioned adjacent to the palate. The nipple structure includes a web which extends beyond the tip of the nipple and, in use, is received between the tongue and the palate. Preferably, the web terminates near the mid-point, front to back, of the hard palate. In any case, a portion of the web is received between the tongue and the hard palate. The web is thin and is substantially thinner than the nipple element. The web is pliable and easily deforms to conform to the shape of the hard palate when pressed thereagainst. Preferably, the web has a featheredge. A pacifier that includes this novel nipple structure will reduce distortion caused by tongue thrusting against a conventional long pacifier nipple. The web, which is received between the tongue and the hard palate, will promote the acceptance and retention of the pacifier by youngsters, especially newborns. Preferably, the improved nipple structure is incorporated in a pacifier.

Accordingly, it is an object of the invention to provide an improved nipple structure for a pacifier.

It is a further object of the present invention to provide a nipple structure with a short nipple element and a thin pliable web which extends from the tip of the nipple element back to a point where the web is received between the tongue and the hard palate.

It is a further object of the invention to provide a pacifier which includes the improved nipple structure to promote acceptance and retention of the pacifier while protecting against maxilla deformation.

These and other objects and advantages of the present invention will no doubt become apparent to those skilled in the art after having read this detailed description of the invention including a description of the preferred embodiments, which are illustrated in FIGS. 1-6.

### BRIEF DESCRIPTION OF THE DRAWINGS

FIG. 1 is a top view of a pacifier which includes an improved nipple structure according to the present invention.

FIG. 2 is a front view showing further details of the pacifier of FIG. 1.

FIG. 3 is a partial side view of the portion of the pacifier of FIG. 1 indicated by a line 3-3 and arrows associated therewith.

FIG. 4 is a top view of a pacifier showing a second embodiment of an improved nipple structure according to the present invention.

FIG. 5 is a top view of a pacifier showing a third embodiment of an improved nipple structure according to the present invention.

FIG. 6 is a top view of a pacifier showing a fourth embodiment of an improved nipple structure according to the present invention.

### DETAILED DESCRIPTION OF THE PREFERRED EMBODIMENTS

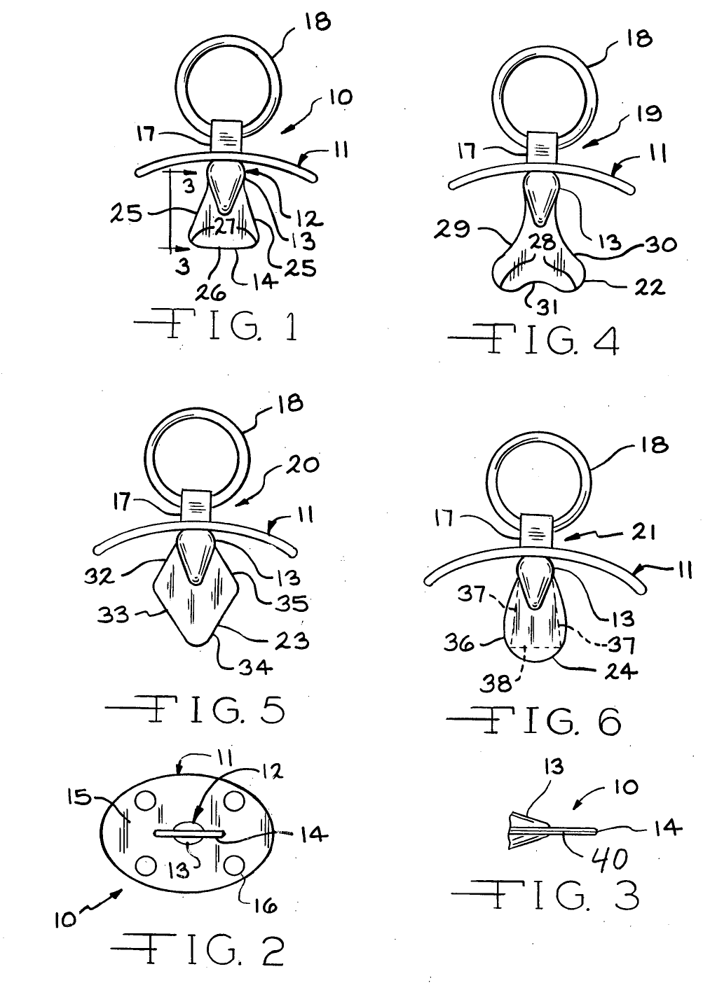

Referring to FIG. 1, a pacifier for an infant or toddler, which includes the improved nipple structure of the invention, is indicated generally at 10. The pacifier 10 comprises a shield 11 and a nipple member 12 which comprises a short nipple element 13 and, extending therefrom and connected thereto, a web 14.

The shield 11 is slightly curved to conform generally to the outer surface of an infant's cheeks and lips. It has a rear surface 15 and is perforated as indicated at 16 (FIG. 2). When the pacifier 10 is in use, the rear surface 15 of the shield 11 is in general contact with the outer surface of the cheeks and lips of an infant. The perforations 16 assist in breaking suction forces developed in the infant's mouth to facilitate removal of the pacifier 10. The shield 11 and the nipple element 12, as shown, are integral with a connector element 17 (FIG. 1), which is generally perpendicular to the axis of the former and parallel to the axis of the latter, although they can be separate pieces which are securely attached to the connector 17. A handle 18 is slidably received in an outer end of the connector 17. The web 14, preferably, is integral with the nipple element 13 and both thin and strong, as well as resistant to tearing and cracking. As shown in FIG. 3, the web 14 can have a uniform thickness. It is preferred, however, that the web 14 be slightly tapered so that it terminates in a featheredge as discussed below with reference to FIG. 3, so that it is thicker adjacent to the nipple element 13 than at the edge. The nipple element 13 and the web 14 are so sized and positioned, relative to the shield 11, that the web 14, when in the mouth of a user, terminates about half way between the alveolar ridge and the rear of the hard palate.

The connector element 17, the nipple element 13, and the web 14 are all preferably formed of a resilient material such as silicone rubber, which simulates the resiliency of a human nipple. The web 14 is very thin and it is very pliable so that when it is pressed by a tongue against a hard palate, the web 14 will deform so that it conforms to the shape of the palate with minimal distortion of the palate due to the presence of the web 14 between the tongue and the hard palate. It is the engagement of the web 14 between a tongue and a hard palate that serves to retain the pacifier in the mouth of a user. The web is so thin and pliable that it only interferes minimally with proper tongue placement against the hard palate during sucking. The thin pliable web eliminates the need, in my prior patented oral appliance, for an inner shield which, among other things, helped to retain the appliance in the mouth. The web serves to maintain the pacifiers shown in FIGS. 1, 4, 5 and 6 in a mouth because the pacifier is designed so that the web, or at least a substantial portion of it, is positioned between the tongue and the hard palate so that it is engaged between them when the appliance is in use. However, the web is so very thin and pliable that it deforms to conform to the shape of the palate when pressed thereagainst by a tongue and, by conforming to the shape of the hard palate, offers only the slightest interference with proper tongue positioning, i.e., minimal interference.

Pacifiers according to the invention which are indicated generally at 19, 20 and 21 in FIGS. 4, 5 and 6, except for the shapes of webs 22, 23 and 24, are identical with the pacifier 10 of FIG. 1, comprising the shield 11, the nipple element 13, the connector element 17 and the handle 18. The web 14 (FIG. 1) has generally the shape of a truncated isosceles triangle with truncated equal sides 25, a base 26, and rounded corners 27. The web 22 (FIG. 4) is similar in shape to a truncated isosceles triangle with rounded comers 28, differing in that the three sides 29, 30 and 31 are curved from each end toward the center of the triangle. The web 23 (FIG. 5) has sides 32, 33, 34 and 35, and is generally diamond shaped with rounded corners, except that the sides 32 and 35 are truncated. The web 24 (FIG. 6) has a continuously curved edge 36 which is a circumscribed curve around a truncated isosceles triangle having truncated equal sides 37 and a base 38.

It is preferred that the webs 14, 22, 23 and 24 be slightly tapered, so that they are thicker adjacent the nipple element 13 than at their edges. As shown in FIG. 3, it is preferred that the web 14 has a featheredge that is indicated at 40. In fact, a featheredge is preferred in all of the web embodiments including webs 22, 23 and 24. This will result in a smooth feeling for a tongue when it passes over the interface between the featheredge of the web and the adjacent portion of the palate. The nipple element 13 and the webs 14, 22, 23 and 24 should be so sized and positioned, relative to the shield 11, that the webs, when in the mouth of a user, terminate at a point which is at least about half way between the alveolar ridge and the rear of the hard palate, but not beyond the hard palate, and that the nipple element extend into the mouth of the user from about one fourth (1/4) as far to about one third (⅓) as far as does the web with which it is associated. When the nipple element and the web are so sized, the web extends inwardly from the nipple element and is received between the tongue and the hard palate. Excellent results can be achieved when the nipple element is from about one centimeter to about one and one half centimeters in length. The web may have a variety of shapes, provided that it is thin and extends back from the nipple element, but not beyond the rear of the hard palate.

The foregoing description is intended to enable one skilled in the art to make and use the invention. and not to limit the scope thereof, which is defined in the following claims.

I claim:

1. A pacifier for an infant or toddler which comprises
a curved shield having a rear surface which generally conforms to the outer surfaces of the cheeks and lips of an infant or toddler,
a nipple structure connected to and supported on said curved shield, said nipple structure having a nipple which extends a short distance from said shield into the mouth of an infant or toddler when the pacifier is in use and the rear surface of said curved shield is in contact with the outer surfaces of the cheeks and lips of the infant or toddler, said nipple having a longitudinal axis and terminating in a distal tip opposite said curved shield, and
a thin web which is structurally integral with said nipple, is very pliable so that it will deform to conform to the shape of a hard palate in a mouth when pressed thereagainst by a tongue and extends longitudinally from the distal tip of said nipple such that the longitudinal axis of said nipple extends through the web, distal to said nipple.

2. The pacifier claimed in claim 1 wherein said thin pliable web is tapered so that it is thicker adjacent said nipple than at its edges.

3. The pacifier claimed in claim 1 wherein said nipple of said nipple structure extends from said shield a distance of from one centimeter to one and one half centimeters.

4. The pacifier claimed in claim 1 wherein said web has a featheredge.

5. A pacifier for an infant or toddler which comprises
a curved shield having a rear surface which generally conforms to the outer surfaces of the cheeks and lips of an infant or toddler,
a nipple structure connected to and supported on said curved shield, said nipple structure having a nipple which extends a short distance from said shield into the mouth of an infant or toddler when the pacifier is in use and the rear surface of said curved shield is in contact with the outer surfaces of the cheeks and lips of the infant or toddler, said nipple having a longitudinal axis and terminating in a distal tip opposite said curved shield and
a thin web which is generally planar and structurally integral with said nipple, is very pliable so that it will deform to conform to the shape of a hard palate in a mouth when pressed thereagainst by a tongue, is thicker in a region adjacent to said nipple and thinner at an edge region of said web, and extends longitudinally from the distal tip of said nipple such that a plane that coincides with the longitudinal axis of and is perpendicular to the plane of said web extends through said web, distal to said nipple.

6. The pacifier claimed in claim 5 wherein said nipple of said nipple structure extends from said shield a distance of from one centimeter to one and one half centimeters.

7. A pacifier for an infant or toddler which comprises
a curved shield having a rear surface which generally conforms to the outer surfaces of the cheeks and lips of an infant or toddler,
a nipple element connected to and supported on said curved shield, said nipple element having a nipple which extends a short distance from said shield into the mouth of an infant or toddler when the pacifier is in use and the rear surface of said curved shield is in contact with the outer surfaces of the cheeks and lips of the infant or toddler, said nipple having a longitudinal axis and terminating in a distal tip opposite said curved shield and
a thin web which is generally planar and structurally integral with said nipple and extends longitudinally from the distal tip of said nipple such that a plane that coincides with the longitudinal axis of and is perpendicular to the plane of said web extends through said web, distal to said nipple, wherein said web is so thin and pliable that, when it is received between the tongue and the hard palate, it interferes only minimally with proper tongue placement during swallowing.

8. The pacifier claimed in claim 7 wherein said web has a featheredge.

9. The pacifier claimed in claim 7 wherein said nipple element extends from said shield a distance of from one centimeter to one and one half centimeters.

10. The pacifier claimed in claim 7 wherein said web is thicker in a region adjacent to said nipple and thinner at an edge region of said web.
